(19) United States
(12) Patent Application Publication
(10) Pub. No.: US 2026/0312687 A1
(43) Pub. Date: Oct. 8, 2026

(54) OPTICAL RELAY APPARATUS, OPTICAL TRANSMISSION SYSTEM, AND OPTICAL RELAY METHOD

(71) Applicant: NEC Corporation, Tokyo (JP)

(72) Inventor: Hidemi NOGUCHI, Tokyo (JP)

(73) Assignee: NEC Corporation, Tokyo (JP)

(21) Appl. No.: 19/478,888

(22) PCT Filed: May 19, 2023
(86) PCT No.: PCT/JP2023/018746

§ 371 Date: Oct. 27, 2025

(51) Int. Cl. H04B 10/294; H04B 10/50

(52) U.S. Cl. CPC H04B 10/294; H04B 10/506

(57) ABSTRACT

An optical relay device (2) according to the present disclosure constitutes an optical transmission system. The optical relay device (2) comprises an optical reception unit (21) that receives optical signals and an optical transmission unit (22) that transmits optical signals. The optical reception unit (21) receives an optical signal of a single wavelength channel from the optical relay device (2) of a preceding stage. The optical transmission unit (22) duplicates the optical signal received by the optical reception unit (21) into optical signals of a plurality of wavelength channels and transmits the duplicated optical signals of the plurality of wavelength channels to an optical relay device (2) of a subsequent stage.

### TECHNICAL FIELD

The present disclosure relates to an optical relay apparatus, an optical transmission system, and an optical relay method.

### BACKGROUND ART

In recent years, the introduction of a 5G wireless communication system has been promoted, and toward the post-5G era, demands for further ultra-low delay and multiple simultaneous connection in addition to ultra-high speed in not only wireless communication but also optical communication fields have been intensified. For this reason, an optical communication system is expected to be utilized for various communication services and industrial applications.

For example, in a backbone optical communication system, a digital coherent method in which an optical phase modulation method and a polarization-demultiplexing technique are combined is used, whereby a large capacity of more than 100 Giga bit per second (Gbps) is achieved. A transmission method also has been researched and developed in which a signal-band is narrowed and wavelength-multiplexed (Wavelength Division Multiplexing: WDM), thereby improving frequency utilization efficiency and enabling multiple simultaneous connection.

However, in a complicated WDM network, due to wavelength conflicts with other signals, it is not possible to establish an end-to-end shortest path using a single wavelength, or restrictions arise, such as being unable to establish a path that avoids a failure. Therefore, it is necessary to establish a path while performing wavelength conversion to available wavelength slots (wavelength channels).

For example, PTL 1 is known as a related technology. PTL 1 discloses a method for converting an optical signal of a single wavelength into an optical signal of another single wavelength in an optical relay apparatus.

### CITATION LIST

### Patent Literature

PTL 1: WO 2022/180846 A1

### SUMMARY OF INVENTION

### Technical Problem

In the related technology such as PTL 1, by converting an optical signal of a single wavelength into an optical signal of another single wavelength, it is possible to efficiently relay the optical signal using available wavelengths. On the other hand, even in a case where network traffic becomes complicated as in multicast transmission, it is desirable to improve frequency utilization efficiency.

In view of such a problem, an object of the present disclosure is to provide an optical relay apparatus, an optical transmission system, and an optical relay method capable of improving frequency utilization efficiency.

### Solution to Problem

According to the present disclosure, there is provided an optical relay apparatus including an optical reception means for receiving an optical signal of a single wavelength, and an optical transmission means for duplicating the received optical signal into optical signals of a plurality of wavelengths and transmitting each of the duplicated optical signals.

According to the present disclosure, there is provided an optical transmission system including a plurality of optical relay apparatuses, in which the plurality of optical relay apparatuses include an optical reception means for receiving an optical signal of a single wavelength from an optical relay apparatus at a preceding stage, and an optical transmission means for duplicating the received optical signal into optical signals of a plurality of wavelengths and transmitting each of the duplicated optical signals to an optical relay apparatus at a subsequent stage.

According to the present disclosure, there is provided an optical relay method including receiving an optical signal of a single wavelength, and duplicating the received optical signal into optical signals of a plurality of wavelengths and transmitting each of the duplicated optical signals.

### Advantageous Effects of Invention

According to the present disclosure, it is possible to provide an optical relay apparatus, an optical transmission system, and an optical relay method capable of improving frequency utilization efficiency.

### BRIEF DESCRIPTION OF DRAWINGS

FIG. 1 is a configuration diagram illustrating a configuration example of an optical transmission system according to an example embodiment.

FIG. 2 is a diagram illustrating an example in which wavelengths collide in an optical transmission system.

FIG. 3 is a diagram illustrating an optical relay apparatus of a study example.

FIG. 4 is a diagram illustrating an optical relay apparatus of a study example.

FIG. 5 is a diagram illustrating a problem in a study example.

FIG. 6 is a diagram illustrating a problem in a study example.

FIG. 7 is a diagram illustrating an outline of an optical relay method according to the example embodiment.

FIG. 8 is a diagram illustrating a problem in a study example.

FIG. 9 is a diagram illustrating an outline of an optical relay method according to the example embodiment.

FIG. 10 is a configuration diagram illustrating an outline configuration of an optical relay apparatus according to the example embodiment.

FIG. 11 is a configuration diagram illustrating a configuration example of an optical relay apparatus according to a first example embodiment.

FIG. 12 is a configuration diagram illustrating a specific configuration example of an optical relay apparatus according to the first example embodiment.

FIG. 13 is a diagram illustrating an operation principle of an LN modulator according to the first example embodiment.

FIG. 14 is a diagram illustrating an operation principle of an LN modulator according to the first example embodiment.

FIG. 15 is a configuration diagram illustrating another configuration example of an optical relay apparatus according to the first example embodiment.

FIG. 16 is a configuration diagram illustrating still another configuration example of an optical relay apparatus according to the first example embodiment.

FIG. 17 is a configuration diagram illustrating a configuration example of an optical relay apparatus according to a second example embodiment.

FIG. 18 is a diagram illustrating another example of a path switching means according to the second example embodiment.

FIG. 19 is a configuration diagram illustrating another configuration example of an optical relay apparatus according to the second example embodiment.

FIG. 20 is a configuration diagram illustrating still another configuration example of an optical relay apparatus according to the second example embodiment.

FIG. 21 is a diagram illustrating an example of a spectrum of an optical signal in the another configuration example of an optical relay apparatus according to the second example embodiment.

FIG. 22 is a diagram illustrating an example of a spectrum of an optical signal in the still another configuration example of an optical relay apparatus according to the second example embodiment.

FIG. 23 is a configuration diagram illustrating a configuration example of an optical transmission system according to a third example embodiment.

FIG. 24 is a configuration diagram illustrating a configuration example of related automatic bias control.

FIG. 25 is a configuration diagram illustrating a configuration example of an optical relay apparatus according to a fourth example embodiment.

FIG. 26 is a configuration diagram illustrating another configuration example of an optical relay apparatus according to the fourth example embodiment.

FIG. 27 is a configuration diagram illustrating still another configuration example of an optical relay apparatus according to the fourth example embodiment.

### EXAMPLE EMBODIMENT

Hereinafter, example embodiments will be described with reference to the drawings. In the drawings, the same or corresponding elements are denoted by the same reference numeral, and redundant description thereof will be omitted as necessary for clarity of description. Arrows illustrated in the drawings are illustrative examples, and do not limit the type or direction of a signal.

### Outline of Example Embodiment

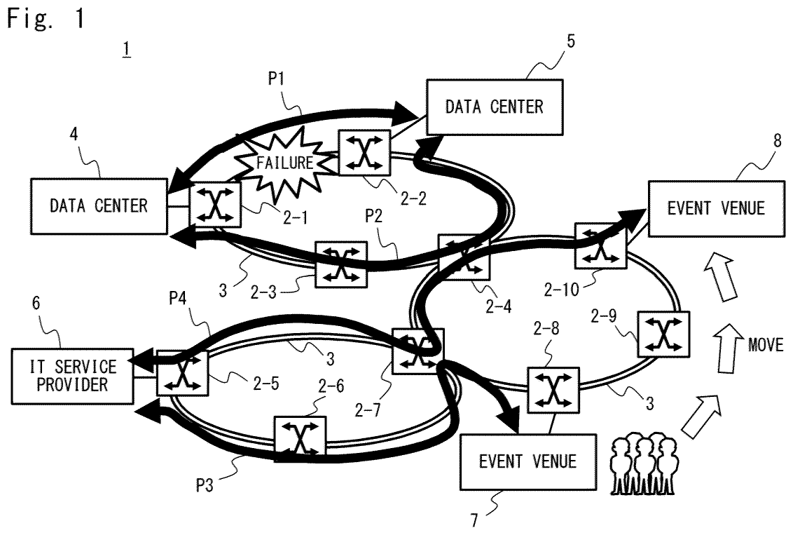

First, an outline of an example embodiment will be described. FIG. 1 illustrates a configuration example of an optical transmission system 1 according to the example embodiment. The optical transmission system 1 according to the example embodiment is, for example, a backbone wavelength-division multiplexing optical transmission system, and performs large-capacity communication exceeding 100 Gbps or of the 1 Tbps level by performing wavelength-division multiplexing and performing digital coherent transmission on optical signals of wavelengths. Through wavelength-division multiplexing, it is possible to improve the frequency utilization efficiency of light and to address mobile traffic and wavelength defragmentation. Since a transmission route (wavelength path) can be flexibly switched while keeping the signal as an optical signal by wavelength-division multiplexing, a failure can be avoided and the infrastructure can be maintained by switching the transmission route at the time of the failure. For the post-5G era, it is possible to improve real-time performance and cope with ultra-low latency, and further, it is possible to achieve a large capacity by a higher-order multi-level modulation scheme.

As illustrated in FIG. 1, the optical transmission system 1 includes a plurality of optical relay apparatuses 2 (for example, 2-1 to 2-10) that are connected via an optical fiber transmission line 3 in such a way as to be able to optically communicate. Each of the optical relay apparatuses 2 is a photonic node capable of relaying a wavelength-division multiplexed optical signal, and is, for example, a Reconfigurable Optical Add/Drop Multiplexer (ROADM) apparatus. In this example, the optical relay apparatuses 2-1 to 2-10 constitute a ring-type network including three rings, but may constitute a network of other topologies.

A wavelength path is allocated to each optical relay apparatus 2, and traffic of the accommodated local network or another optical relay apparatus 2 is transferred via the allocated wavelength path. For example, the optical relay apparatus 2-1 accommodates a network of a data center 4, and the optical relay apparatus 2-2 accommodates a network of a data center 5, and large capacity traffic such as a video streaming service that delivers a high-quality video (4 k/8 k) is transferred. For example, if a failure occurs in a wavelength path P1 while the optical relay apparatus 2-1 and the optical relay apparatus 2-2 are transferring traffic between the data center 4 and the data center 5 via the wavelength path P1, the wavelength path Pl is switched to a wavelength path P2. Thus, the transfer of the traffic between the data center 4 and the data center 5 can be maintained via a bypass route including the optical relay apparatus 2-3 and the optical relay apparatus 2-4.

For example, the optical relay apparatus 2-5 accommodates an IoT sensor network of an IT service provider 6, and the optical relay apparatus 2-8 accommodates a mobile network of an event venue 7. Traffic of the mobile network is traffic resulting from spot demand caused by a moving user. While the user at the event venue 7 moves to an event venue 8 while the optical relay apparatus 2-5 and the optical relay apparatus 2-8 are transferring traffic between the IT service provider 6 and the event venue 7 via a wavelength path P3 including the optical relay apparatus 2-6 and the optical relay apparatus 2-7, the wavelength path P3 is switched to a wavelength path P4. Thus, the transfer of the traffic from the user who moves to the event venue 8 via the optical relay apparatus 2-7, the optical relay apparatus 2-4, and the optical relay apparatus 2-10 can be maintained.

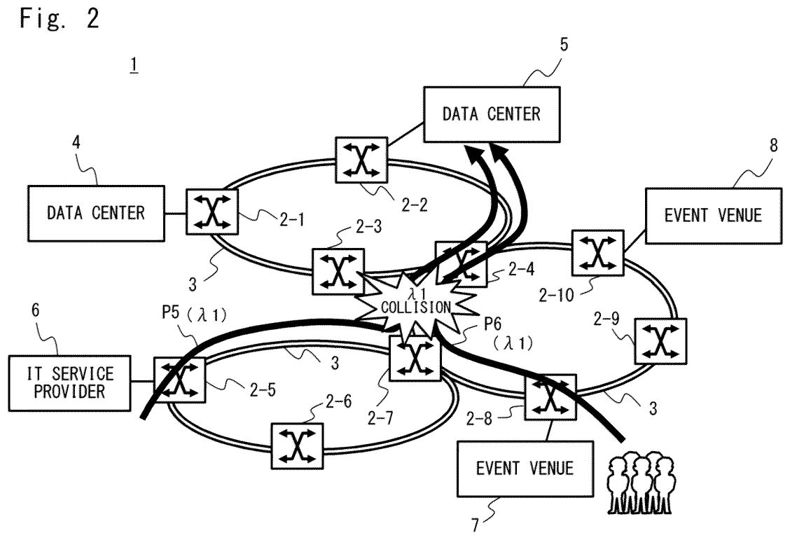

As illustrated in FIG. 2, while the optical relay apparatus 2 relays an optical signal, optical signals having the same wavelength may collide with each other. For example, in a case where a wavelength path P5 is set between the optical relay apparatus 2-2 and the optical relay apparatus 2-5 and traffic is transferred between the IT service provider 6 and the data center 5, it is assumed that a wavelength path P6 is set between the optical relay apparatus 2-2 and the optical relay apparatus 2-8 and traffic is transferred between the event venue 7 and the data center 5. At this time, in a case where the wavelength slots (wavelength channels) of the wavelength path P5 and the wavelength path P6 are the same 21, the optical signal of the wavelength path P5 and the optical signal of the wavelength path P6 collide with each other in the optical relay apparatus 2-7.

In this case, a method for avoiding collision by switching the wavelength path P5 or the wavelength path P6 to another route is conceivable, but the wavelength slot of the another route is not necessarily available. Even if the path is switched, a bypass path may increase latency. Therefore, a method for preventing collision by converting an optical signal of a single wavelength into an optical signal of another single wavelength is conceivable.

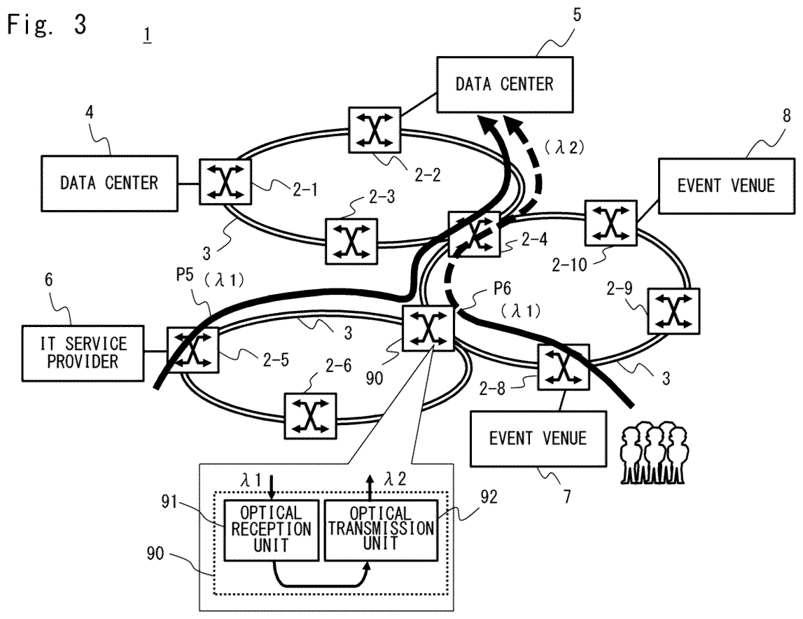

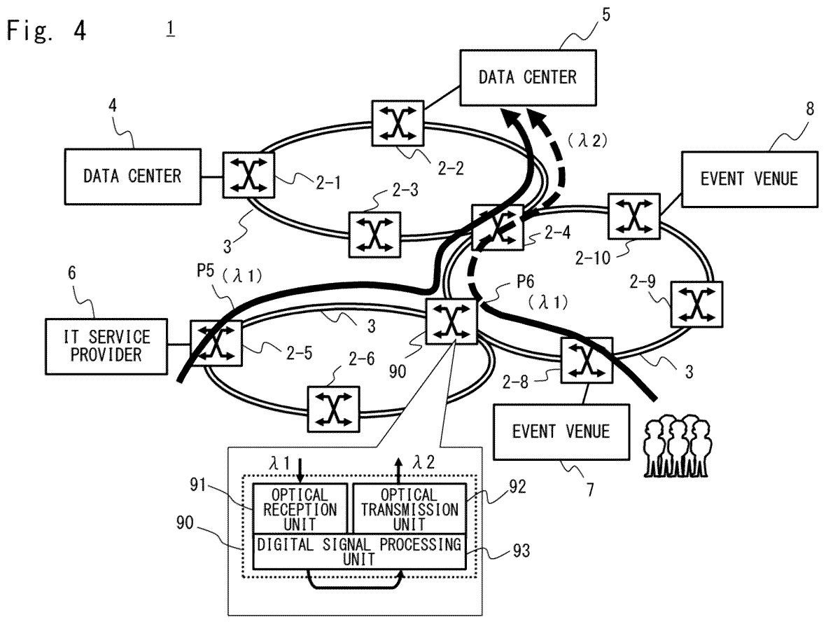

FIGS. 3 and 4 illustrate a study example in which an optical signal of a single wavelength is converted into an optical signal of another single wavelength in the optical relay apparatus. For example, in an optical relay apparatus 90 in the study example, the wavelength of the optical signal of the wavelength path P6 is converted from 21 to 22. Thus, since the wavelength of the optical signal of the wavelength path P5 and the wavelength of the optical signal of the wavelength path P6 are different from each other in the route from the optical relay apparatus 90 to the optical relay apparatus 2-2, collision can be avoided.

The optical relay apparatus 90 of the study example in FIG. 3 includes an optical reception unit 91 that performs optical-to-electrical conversion on an optical signal of a single wavelength received, and an optical transmission unit 92 that performs electrical-to-optical conversion on the optically-to-electrically converted electrical signal into an optical signal of a single wavelength and transmits the converted optical signal. Simple analog signal processing may be included between the optical reception unit 91 and the optical transmission unit 92. In the study example of FIG. 3, an analog signal is simply looped back between the optical reception unit 91 and the optical transmission unit 92, and optical-to-electrical (analog)-optical conversion is performed, and thus wavelength conversion is implemented. Thus, miniaturization and power saving can be achieved, and latency can be suppressed. On the other hand, in the study example of FIG. 3, there is a possibility that signal degradation occurs due to passage through the optical transmission line and the optical transmission/reception circuit.

The optical relay apparatus 90 of the study example in FIG. 4 includes a digital signal processing unit 93 that performs digital signal processing between the optical reception unit 91 and the optical transmission unit 92. In the study example of FIG. 4, the digital signal is looped back via the digital signal processing unit 93 between the optical reception unit 91 and the optical transmission unit 92 to perform wavelength conversion. The digital signal processing unit 93 includes an analog/digital converter (ADC), a digital/analog converter (DAC), and a digital signal processor (DSP). For example, the digital signal processing is simple digital signal processing except for complex digital signal processing (large-scale wavelength dispersion compensation, dynamic equalization, error correction processing, and the like) with high latency, large circuit size, and high power consumption. In the study example of FIG. 4, the signal degradation can be suppressed by performing regeneration and relay by digital signal processing.

The inventor has studied a relay method for wavelength conversion as in the study examples of FIGS. 3 and 4, and has found the following problems.

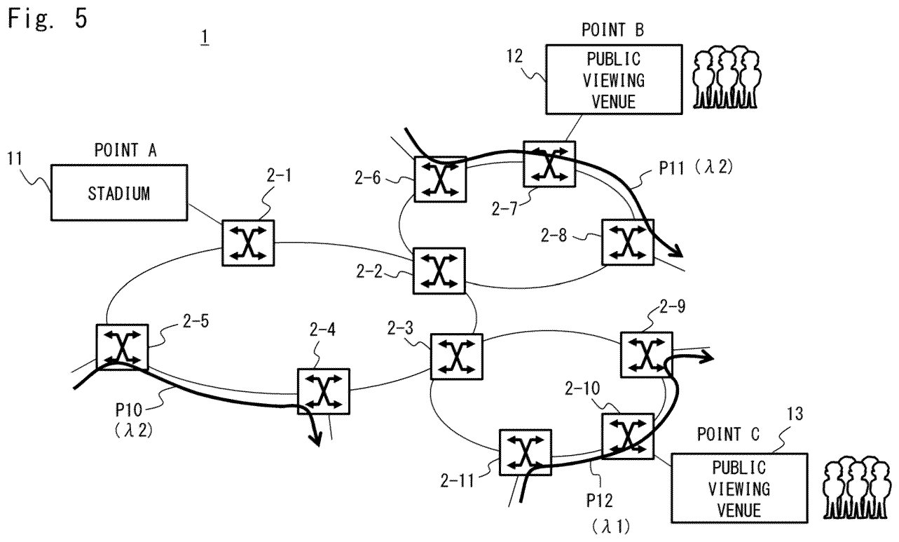

For example, as illustrated in FIG. 5, the optical transmission system 1 includes optical relay apparatuses 2-1 to 2-11. In the example of FIG. 5, the wavelength λ2 is allocated to a wavelength path P10 including the optical relay apparatuses 2-4 and 2-5, the wavelength λ2 is allocated to a wavelength path P11 including the optical relay apparatuses 2-6, 2-7, and 2-8, and the wavelength λ1 is allocated to a wavelength path P12 including the optical relay apparatuses 2-9, 2-10, and 2-11.

In this state, a case where the same data (for example, a live soccer video) is multicast-delivered from a stadium 11 at a point A to a public viewing venue 12 at a point B, and a public viewing venue 13 at a point C will be considered.

However, it is assumed that there are only λ1 and λ2 available wavelength slots in the optical relay apparatus 2-1 at the point A on the transmission side.

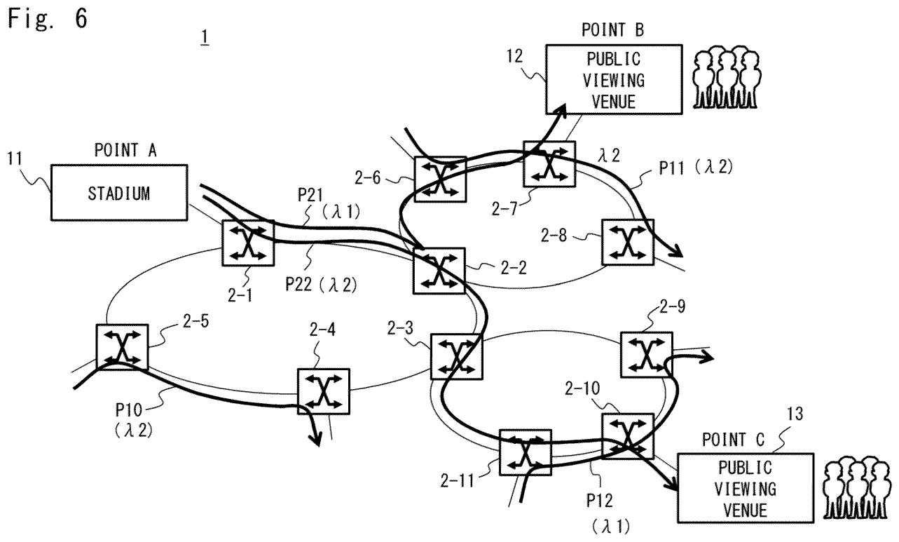

Therefore, for example, as illustrated in FIG. 6, a wavelength path P21 of λ1 is allocated to a route including the optical relay apparatuses 2-1, 2-2, 2-6, and 2-7 between the point A and the point B, and a wavelength path P22 of λ2 is allocated to a route including the optical relay apparatuses 2-1, 2-2, 2-3, 2-11, and 2-10 between the point A and the point C. Data can be delivered from the point A to the points B and C by using the wavelength channel of λ1 between the points A and B and using a wavelength channel of λ2 between the points A to C.

However, in the example of FIG. 6, although the same data is transmitted through the optical transmission line between the optical relay apparatus 2-1 and the optical relay apparatus 2-2, two wavelength slots of λ1 and λ2 are occupied.

Therefore, in a case where 1:N multicast transmission is performed, wavelength slots of N channels are occupied, and thus there is a problem that frequency utilization efficiency is poor.

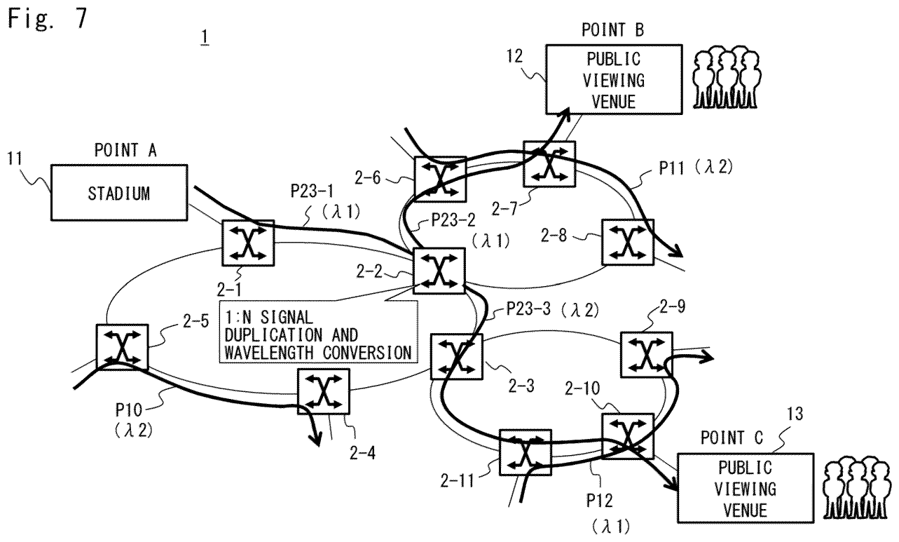

In the example embodiment, in the optical relay apparatus 2, an optical signal of a single wavelength is input, and the optical signal is duplicated and wavelength-converted into optical signals of a plurality of wavelengths. For example, as illustrated in FIG. 7, in the optical relay apparatus 2-2, the optical signal of the wavelength channel of λ1 is input, and the optical signal of the wavelength channel of λ1 is duplicated into the optical signals of the wavelength channels of λ1 and λ2 to perform wavelength conversion. That is, the data from the point A is transmitted using the wavelength channel of λ1 on a wavelength path P23-1 between the optical relay apparatuses 2-1 and 2-2, the duplicated data is transmitted to the point B using the wavelength channel of λ1 on a wavelength path P23-2 among the optical relay apparatuses 2-2, 2-6, and 2-7, and the duplicated data is transmitted to the point C using the wavelength channel of λ2 on a wavelength path P23-3 among the optical relay apparatuses 2-2, 2-3, 2-11, and 2-10. Thus, since the number of wavelength slots occupied between the optical relay apparatus 2-1 and the optical relay apparatus 2-2 can be reduced, the frequency utilization efficiency can be improved.

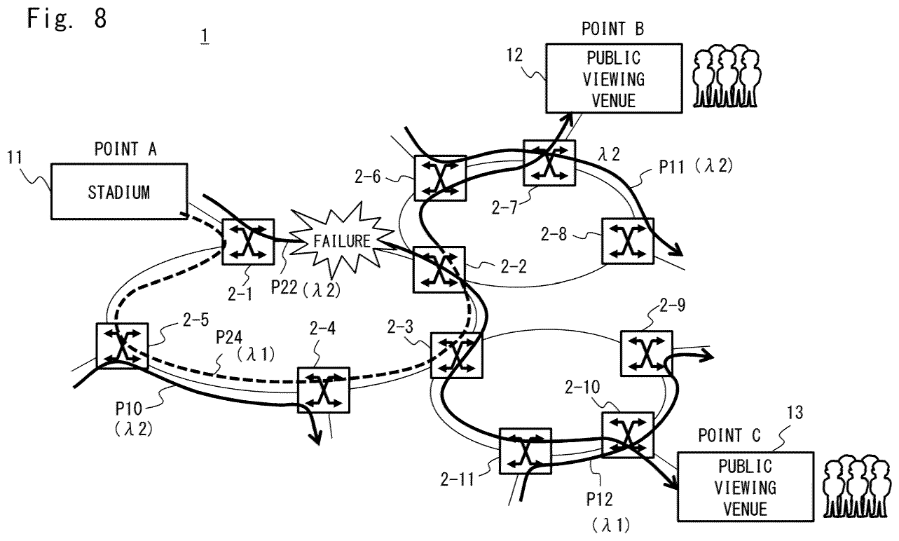

As illustrated in FIG. 6, a case where a failure occurs in the optical transmission line in a state where data is delivered from the point A to the points B and C will be considered. For example, in a case where a failure occurs in a part between the points A to C, there is no bypass route of the optical signal of λ2. Specifically, as illustrated in FIG. 8, for example, in a case where a failure occurs in the optical transmission line between the optical relay apparatus 2-1 and the optical relay apparatus 2-2, for the optical signal of λ1 between the points A and B, data can be transmitted by bypassing the optical signal using a wavelength path P24 including the optical relay apparatuses 2-2, 2-5, 2-4, 2-3, 2-2, 2-6, and 2-7. However, since 22 is used on the wavelength path P10 between the optical relay apparatuses 2-5 and 2-4 for the optical signal of λ2 between the points A to C, the optical signal cannot be bypassed while maintaining 12. Therefore, there is a problem that the wavelength path cannot be switched in a case where 1:N multicast transmission is performed.

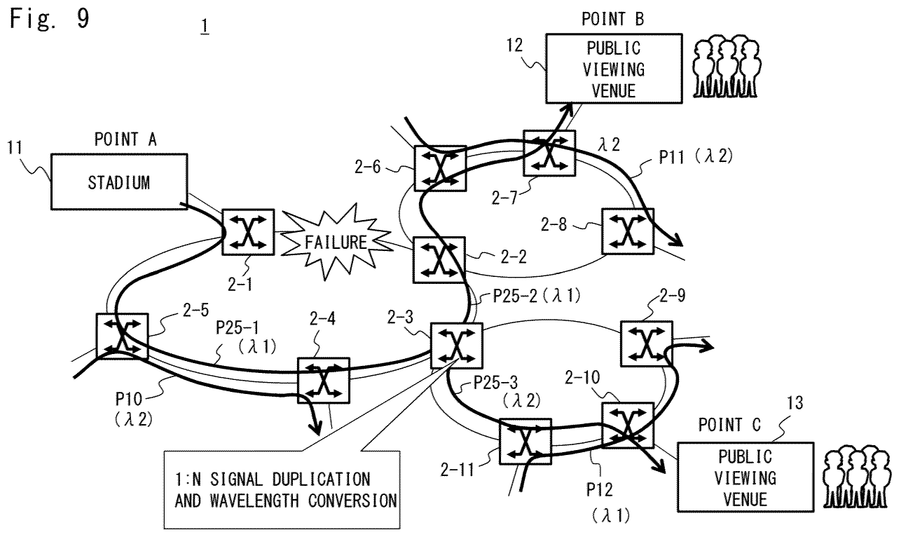

In the example embodiment, as illustrated in FIG. 7, in the optical relay apparatus 2, an optical signal of a single wavelength is input, and the optical signal is duplicated and wavelength-converted into optical signals of a plurality of wavelengths. For example, as illustrated in FIG. 9, in the optical relay apparatus 2-3, the optical signal of the wavelength channel of λ1 is input, and the optical signal of the wavelength channel of λ1 is duplicated into the optical signals of the wavelength channels of λ1 and λ2 to perform wavelength conversion. That is, the data from the point A is transmitted using the wavelength channel of λ1 on a wavelength path P25-1 among the optical relay apparatuses 2-1, 2-5, 2-4, and 2-3, the duplicated data is transmitted to the point B using the wavelength channel of λ1 on a wavelength path P25-2 among the optical relay apparatuses 2-3, 2-2, 2-6, and 2-7, and the duplicated data is transmitted to the point C using the wavelength channel of λ2 on a wavelength path P25-3 among the optical relay apparatuses 2-3, 2-11, and 2-10. Thus, in a case where a failure occurs between the optical relay apparatus 2-1 and the optical relay apparatus 2-2, data can be transmitted from the point A to the points B and C via the bypass route among the optical relay apparatuses 2-1, 2-5, 2-4, and 2-3.

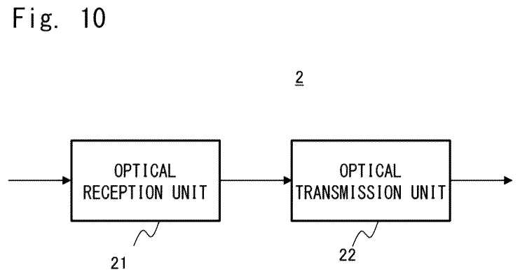

FIG. 10 illustrates an outline configuration of the optical relay apparatus 2 according to the example embodiment. As illustrated in FIG. 10, the optical relay apparatus 2 according to the example embodiment includes an optical reception unit 21 and an optical transmission unit 22. The optical reception unit 21 receives an optical signal of a single wavelength (wavelength channel). The optical transmission unit 22 duplicates the optical signal received by the optical reception unit 21 into optical signals of a plurality of wavelengths (wavelength channels), and transmits the duplicated optical signal. It can also be said that the optical transmission unit 22 wavelength-converts an optical signal of a single wavelength into optical signals of a plurality of wavelengths. That is, the optical transmission unit 22 duplicates and wavelength-converts an optical signal of a single wavelength into optical signals of a plurality of wavelengths.

As described above, if the network traffic becomes complicated such as in multicast transmission, frequency utilization efficiency decreases, and it may be difficult to efficiently avoid wavelength collision associated with path switching for failure avoidance and traffic optimization. In the example embodiment, in the optical relay apparatus, an input optical signal of a single wavelength is duplicated and wavelength-converted into optical signals of a plurality of wavelengths, and an optical relay apparatus having a 1:N signal duplication function and a wavelength conversion function is configured. Thus, it is possible to improve the frequency utilization efficiency of a WDM network system while implementing a multicast function in the optical relay apparatus and avoiding wavelength collision due to path switching, and it is possible to improve the flexibility of path selection.

### First Example Embodiment

Next, a first example embodiment will be described. In the present example embodiment, an example will be described in which in the optical relay apparatus, an input optical signal of a single wavelength is duplicated and wavelength-converted into optical signals of a plurality of wavelength channels.

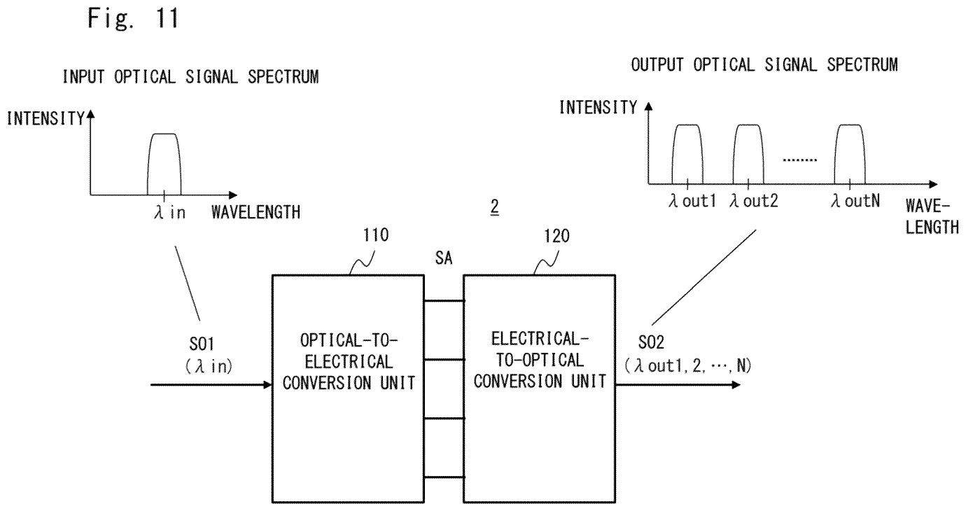

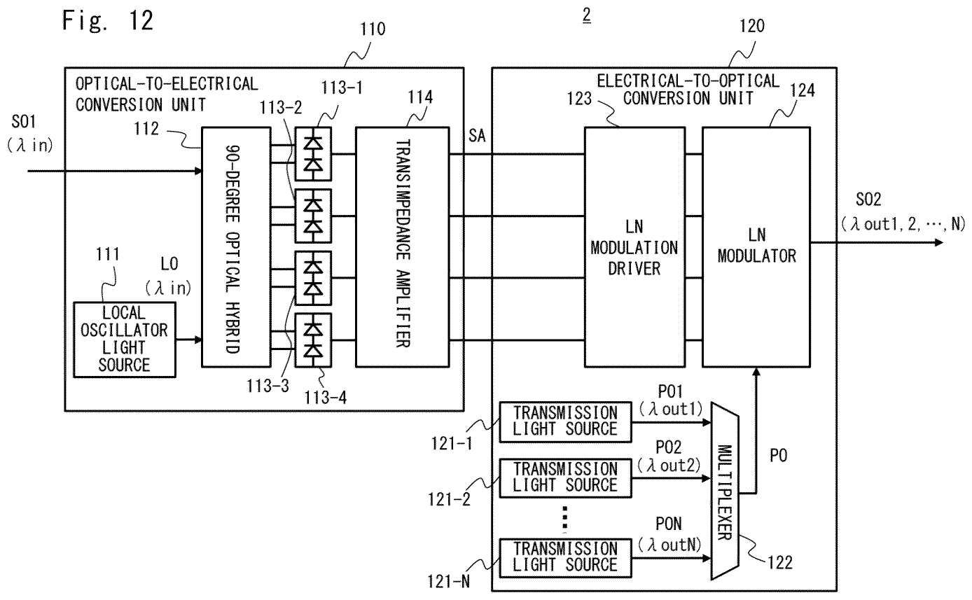

FIG. 11 illustrates a configuration example of the optical relay apparatus 2 according to the present example embodiment, and FIG. 12 illustrates a specific configuration example of each unit in FIG. 11. As illustrated in FIG. 11, the optical relay apparatus 2 according to the present example embodiment includes an optical-to-electrical conversion unit 110 and an electrical-to-optical conversion unit 120.

The optical-to-electrical conversion unit (O/E conversion unit) 110 is an optical reception unit that receives an input optical signal SO1 from the optical relay apparatus 2 at the preceding stage via the optical fiber transmission line 3, and is a conversion unit that converts the received input optical signal SO1 into an analog electrical signal SA. The optical-to-electrical conversion unit 110 performs coherent detection on an input optical signal SO1 to be input based on local oscillator light LO, and outputs an analog electrical signal SA generated by the coherent detection.

The electrical-to-optical conversion unit (E/O conversion unit) 120 is a conversion unit that converts the analog electrical signal SA into an output optical signal SO2, and is an optical transmission unit that transmits the converted output optical signal SO2 to the optical relay apparatus 2 at the subsequent stage via the optical fiber transmission line 3. The electrical-to-optical conversion unit 120 performs coherent modulation (IQ modulation) on transmission light PO based on the analog electrical signal SA generated by the optical-to-electrical conversion unit 110, and outputs the output optical signal SO2 generated by the coherent modulation.

For example, the input optical signal SO1 and the output optical signal SO2 are optical signals subjected to phase modulation and polarization-multiplexing. The analog electrical signal SA is a 4-lane (4 ch) signal including an XI signal of an I component (in-phase component) of the X polarized wave, an XQ signal of a Q component (quadrature component) of the X polarized wave, a YI signal of the I component of the Y polarized wave, and a YQ signal of the Q component of the Y polarized wave. In the present example embodiment, the input optical signal SO1 is an optical signal of a single wavelength (λin), and the output optical signal SO2 includes optical signals of a plurality of wavelengths (λout1 to λoutN). That is, the optical relay apparatus 2 generates optical signals of a plurality of wavelengths (λout1 to λoutN) from an optical signal of a single wavelength (λin), and performs 1:N multicast transmission. That is, the optical-to-electrical conversion unit 110 receives an optical signal of a single wavelength channel, and the electrical-to-optical conversion unit 120 duplicates the received optical signal into optical signals of a plurality of different wavelength channels, and transmits the duplicated optical signals.

As illustrated in FIG. 12, the optical-to-electrical conversion unit 110 includes a local oscillator light source 111, a 90-degree optical hybrid 112, photodetectors 113-1 to 113-4, and a transimpedance amplifier 114.

The local oscillator light source 111 generates local oscillator light LO of a predetermined wavelength (λin) and outputs the generated local oscillator light LO to the 90-degree optical hybrid 112. The frequency of the generated local oscillator light LO is the frequency (carrier frequency or frequency of λin) of the received input optical signal SO1. The local oscillator light source 111 is a wavelength-tunable light source, and can set the wavelength of the local oscillator light LO in accordance with the wavelength of the received input optical signal SO1. The term “frequency” of the signal or the “wavelength” of the signal will be used for description, but the “frequency” and the “wavelength” are interchangeable with each other.

The 90-degree optical hybrid 112 coherently detects the received input optical signal SO1 using the local oscillator light LO output from the local oscillator light source 111. The 90-degree optical hybrid 112 polarization-separates the input optical signal SO1, which is the input polarization-combined signal, into the X polarized wave and the Y polarized wave, and performs coherent detection by causing the polarization-separated optical signal and the local oscillator light LO of the local oscillator light source 111 to interfere with each other. The 90-degree optical hybrid 112 outputs an XI component, an XQ component, a YI component, and a YQ component of the detected input optical signal SO1.

The photodetectors 113-1 to 113-4 optically-to-electrically convert the XI component, the XQ component, the YI component, and the YQ component of the input optical signal SO1 detected by the 90-degree optical hybrid 112, and output the optically-to-electrically converted XI signal, XQ signal, YI signal, and YQ signal of the analog electrical signal.

The transimpedance amplifier (TIA) 114 amplifies the XI signal, the XQ signal, the YI signal, and the YQ signal respectively generated by the photodetectors 113-1 to 113-4, and outputs the amplified XI signal, XQ signal, YI signal, and YQ signal to the electrical-to-optical conversion unit 120 as a 4-lane analog electrical signal SA.

The electrical-to-optical conversion unit 120 includes transmission light sources 121-1 to 121-N, a multiplexer 122, an LN modulation driver 123, and an LN modulator 124.

The LN modulation driver 123 amplifies the XI signal, the XQ signal, the YI signal, and the YQ signal of the analog electrical signal SA output from the optical-to-electrical conversion unit 110, and drives the LN modulator 124 based on the amplified XI signal, XQ signal, YI signal, and YQ signal.

The LN modulator 124 is a coherent modulator (IQ modulator) formed of LN (lithium niobate:LiNbO₃). For example, the LN modulator 124 includes a plurality of Mach Zehnder Modulators (MZ modulator (MZM)). The LN modulator 124 performs IQ modulation on the input transmission light PO in accordance with the XI signal, the XQ signal, the YI signal, and the YQ signal which are applied from the LN modulation driver 123. The LN modulator 124 generates an IQ modulation optical signal of an X polarized wave based on the XI signal and the XQ signal from the LN modulation driver 123, generates an IQ modulation optical signal of a Y polarized wave based on the YI signal and the YQ signal from the LN modulation driver 123, polarization-combines the generated IQ modulation optical signal of the X polarized wave and the generated IQ modulation optical signal of the Y polarized wave, and outputs the combined optical signal as the output optical signal SO2. Other modulators having the same function may be used without being limited to the LN modulator 124.

The frequency of the transmission light PO input to the LN modulator 124 is the frequency (carrier frequency or frequency of Nout) of the transmitted output optical signal SO2. The wavelength of the optical signal can be switched by changing the frequencies of the local oscillator light LO and the transmission light PO. That is, the input optical signal SOI can be converted into the output optical signal SO2 of a different wavelength. In the present example embodiment, the transmission light PO to be input to the LN modulator 124 is generated by the transmission light sources 121-1 to 121-N and the multiplexer 122.

The transmission light sources 121-1 to 121-N generate transmission light beams POI to PON of different wavelengths (λout1 to λoutN), and output the generated transmission light beams PO1 to PON to the multiplexer 122. The transmission light beams PO1 to PON are optical signals with different wavelengths and the same intensity. Thus, it is possible to modulate a plurality of optical signals with the same intensity and different wavelengths. The transmission light sources 121-1 to 121-N are light sources corresponding to the number of wavelengths duplicated by the LN modulator 124 (the number of wavelengths after conversion). That is, the number of transmission light sources 121 corresponds to the number N of branches in a case where 1:N multicast transmission is performed. For example, the number N of optical signals to be duplicated may be changed to an arbitrary number by turning on/off the output of each transmission light source 121. The frequencies of the transmission light beams POI to PON are a plurality of frequencies (carrier frequencies or frequencies of λout1 to λoutN) of the output optical signal SO2. The transmission light sources 121-1 to 121-N are wavelength-tunable light sources, and the wavelength of each transmission light source 121 can be arbitrarily set in accordance with the wavelengths of the optical signal to be duplicated. A plurality of the transmission light sources 121 corresponding to all wavelengths that can be used in the WDM network may be prepared in advance, and the transmission light source 121 corresponding to the wavelength of the optical signal to be duplicated may be used.

The multiplexer 122 is a multiplexing unit such as an optical coupler, multiplexes the transmission light beams POI to PON output from the transmission light sources 121-1 to 121-N, and outputs the multiplexed optical signal to the LN modulator 124 as the transmission light PO.

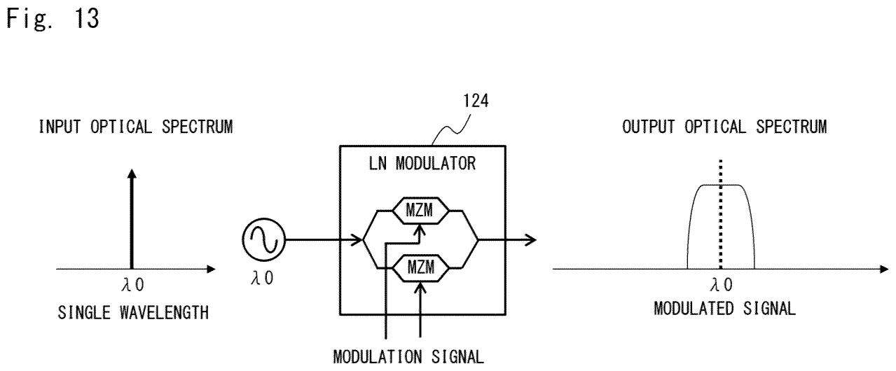

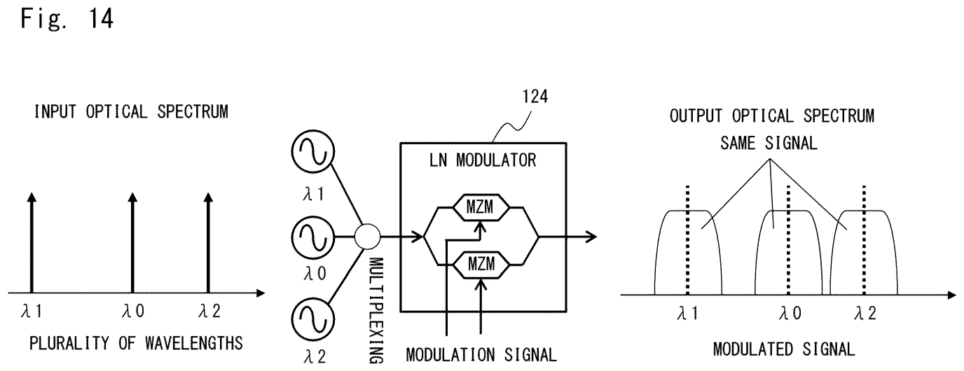

Once continuous wave (CW) light beams of a plurality of wavelengths are input to the LN modulator 124, all the CW light beams are modulated with the same electrical signal, and a plurality of optical signals of different wavelengths are generated. That is, the LN modulator 124 simultaneously collectively modulates light beams of a plurality of wavelengths with the same electrical signal. The operation principle of the LN modulator 124 will be described with reference to FIGS. 13 and 14.

FIG. 13 illustrates an operation example in a case where an optical signal of a single wavelength is input to the LN modulator 124. As illustrated in FIG. 13, an optical signal of a single wavelength (for example, λ0) (CW light from a light source) is input to the LN modulator 124, and the LN modulator 124 is driven by the modulation signal (electrical signal from a modulation driver).

Specifically, the optical signal of a single wavelength (λ20) is input to each waveguide (arm) of the LN modulator 124 (MZ modulator), and the modulation signal is applied. Then, since the refractive index of each waveguide changes in accordance with the modulation signal, the phase and intensity of the optical signal of a single wavelength (λ0) are modulated. Therefore, an optical signal obtained by modulating the optical signal of a single wavelength (λ0) in accordance with the modulation signal (modulated signal) is output. The output optical signal is a signal in which the modulation signal is superimposed on a single carrier frequency (wavelength λ0), and has a spectrum with a predetermined bandwidth centered on the single carrier frequency (wavelength λ0).

FIG. 14 illustrates an operation example in a case where optical signals of a plurality of wavelengths are input to the LN modulator 124. As illustrated in FIG. 14, an optical signal obtained by multiplexing a plurality of wavelengths (for example, λ0, λ1, and λ2) is input to the LN modulator 124, and is driven by the modulation signal. Specifically, the optical signals of a plurality of wavelengths (λ0, λ1, and λ2) are input to each waveguide of the LN modulator 124, and the modulation signal is applied. Then, since the refractive index of each waveguide changes in accordance with the modulation signal, the phase and intensity of optical signals of a plurality of wavelengths (λ0, λ1, and λ3) are collectively modulated. Therefore, an optical signal (modulated signal) obtained by modulating the optical signals of a plurality of wavelengths (λ0, λ1, and λ2) in accordance with the modulation signal is output. The output optical signal is a signal in which the same modulation signal is superimposed on a plurality of carrier frequencies (wavelengths λ0, λ1, and λ2), and has a plurality of spectra with a predetermined bandwidth centered on the plurality of carrier frequencies (wavelengths λ0, λ1, and λ2). That is, by inputting optical signals of a plurality of wavelengths to the LN modulator 124, the same signal is duplicated into signals of a plurality of wavelengths. The duplicated signals have different wavelengths but are the same signals.

In the present example embodiment, as illustrated in FIG. 12, the LN modulator 124 duplicates (modulates) the same signal into a plurality of wavelengths based on the transmission light beams POI to PON of wavelengths λout1 to λoutN. That is, the optical signal obtained by multiplexing the transmission light beams POI to PON of the wavelengths λout1 to λoutN is input to the LN modulator 124, and the LN modulator 124 collectively modulates the transmission light beams POI to PON of the wavelengths λout1 to λoutN with the electrical signal from the LN modulation driver 123 and duplicates the same signal into a plurality of wavelengths. The output optical signal SO2 collectively modulated by the LN modulator 124 includes duplicated optical signals of carrier frequencies of λout1 to λoutN. The spectrum of the output optical signal SO2 indicates a plurality of spectra with predetermined bandwidths respectively centered on λout1, λout2, . . . , and λoutN.

In the example of FIG. 12, the analog electrical signal SA output from the optical-to-electrical conversion unit 110 is input to the electrical-to-optical conversion unit 120, but a signal based on the analog electrical signal SA output from the optical-to-electrical conversion unit 110 may be input to the electrical-to-optical conversion unit 120. For example, a signal obtained by performing predetermined signal processing on the analog electrical signal SA may be input to the electrical-to-optical conversion unit 120.

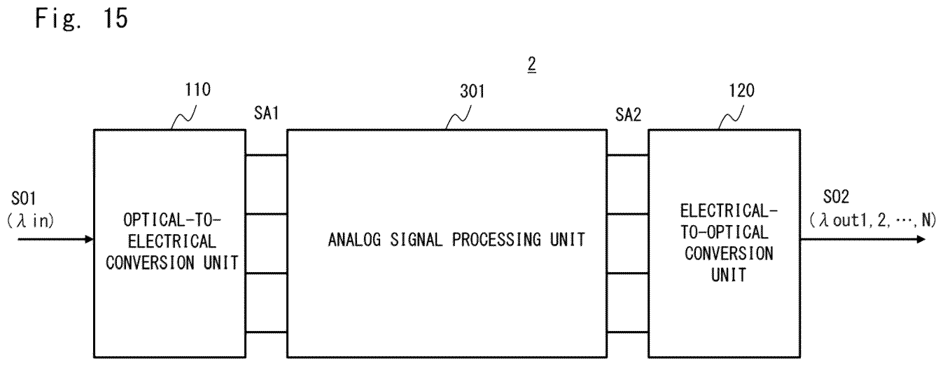

FIG. 15 illustrates an example in which an analog signal processing unit 301 is provided between the optical-to-electrical conversion unit 110 and the electrical-to-optical conversion unit 120. In the example of FIG. 15, the optical-to-electrical conversion unit 110 converts the input optical signal SO1 to be input into an analog electrical signal SA1.

The analog signal processing unit 301 performs predetermined analog signal processing on the analog electrical signal SAI generated by the optical-to-electrical conversion unit 110, and outputs an analog electrical signal SA2 subjected to analog signal processing. The analog signal processing is compensation processing for compensating for the quality of the signal transmitted by an analog circuit, and is, for example, processing such as bandwidth compensation, skew compensation, or gain compensation. The electrical-to-optical conversion unit 120 converts the analog electrical signal SA processed by the analog signal processing unit 301 into the output optical signal SO2. By looping back the signal subjected only to the analog signal processing between the optical-to-electrical conversion unit 110 and the electrical-to-optical conversion unit 120, the degradation of signal quality can be suppressed while suppressing delay.

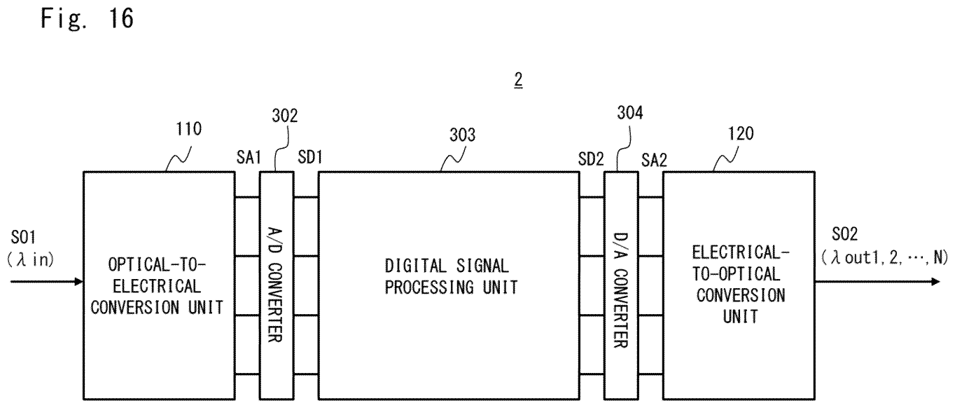

FIG. 16 illustrates an example in which an A/D converter 302, a digital signal processing unit 303, and a D/A converter 304 are provided between the optical-to-electrical conversion unit 110 and the electrical-to-optical conversion unit 120. In the example of FIG. 16, the optical-to-electrical conversion unit 110 converts the input optical signal SO1 to be input into an analog electrical signal SA1. The A/D converter 302 performs AD conversion on the analog electrical signal SA1 generated by the optical-to-electrical conversion unit 110, and outputs a converted digital electrical signal SD1.

The digital signal processing unit 303 performs predetermined digital signal processing on the digital electrical signal SD1 generated by the A/D converter 302 and outputs a digital electrical signal DA2 subjected to digital signal processing. The digital signal processing is compensation processing for compensating for the quality of the signal transmitted by a digital circuit, and is, for example, processing such as bandwidth compensation, skew compensation, gain compensation, wavelength dispersion compensation, or frequency offset compensation.

The D/A converter 304 DA—converts a digital electrical signal SD2 subjected to signal processing by the digital signal processing unit 303, and outputs the converted analog electrical signal SA2. The electrical-to-optical conversion unit 120 converts the analog electrical signal SA processed by the analog signal processing unit 301 into the output optical signal SO2. By looping back the signal subjected to the digital signal processing between the optical-to-electrical conversion unit 110 and the electrical-to-optical conversion unit 120, the degradation of signal quality can be further suppressed.

As described above, in the present example embodiment, in the electrical-to-optical conversion unit on the transmission side of the optical relay apparatus, the CW light beams from a plurality of wavelength-tunable light sources are input to the modulator, the received optical signal of a single wavelength is collectively modulated with the same electrical signal obtained by optical-to-electrical conversion, and thus the signal is duplicated and wavelength-converted into signals of a plurality of wavelengths. Thus, since 1:N optical relay can be performed, frequency utilization efficiency can be improved, and flexibility in communication path selection can be improved.

### Second Example Embodiment

Next, a second example embodiment will be described. In the present example embodiment, an example in which the optical relay apparatus of the first example embodiment includes a path switching unit will be described.

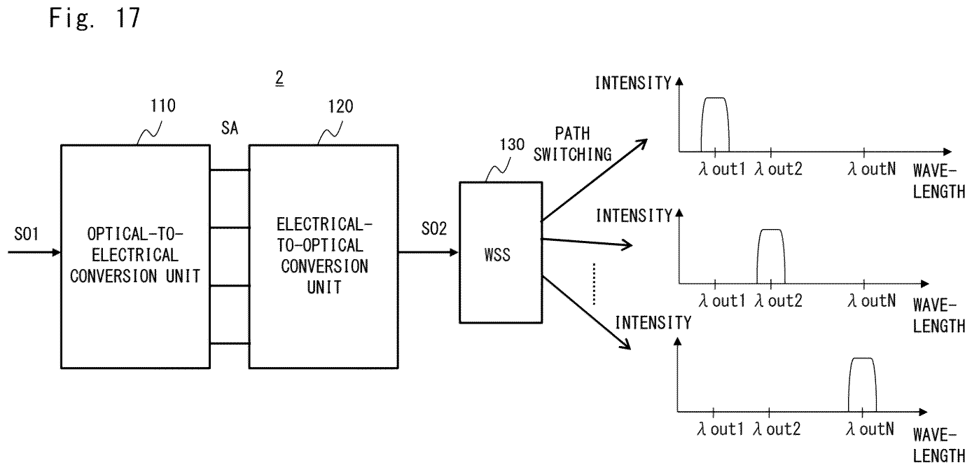

FIG. 17 illustrates a configuration example of the optical relay apparatus 2 according to the present example embodiment. As illustrated in FIG. 17, the optical relay apparatus 2 may further include a WSS 130 as a path switching unit in addition to the configuration of the first example embodiment. The wavelength selective switch (WSS) 130 is a 1:N switch, and the WSS 130 switches the output path of the output optical signal SO2 output from the electrical-to-optical conversion unit 120 for each wavelength. The output path is an optical fiber transmission line to which an optical signal is output. For example, in a case where the output optical signal SO2 includes optical signals of wavelengths λout1 to λoutN, the WSS 130 outputs the optical signal of the wavelength λout1 to a first path, outputs the optical signal of the wavelength λout1 to a second path, and . . . outputs the optical signal of the wavelength λoutN to an N-th path. Optical signals of a plurality of wavelengths may be output to one output path.

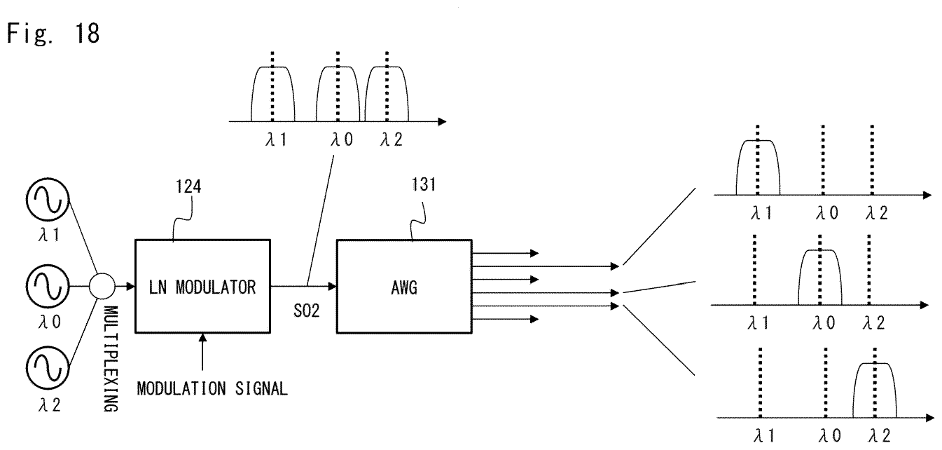

The WSS 130 is an example of a path switching unit that switches a path for each wavelength, and may be configured by other switching means. For example, as illustrated in FIG. 18, an AWG 131 may be provided instead of the WSS 130. The AWG can easily configure the path switching unit.

An arrayed waveguide grating (AWG) 131 is a 1:N optical input/output device, and the AWG 131 outputs an optical signal from an output port corresponding to a wavelength of an input optical signal. The AWG 131 can switch the output path in accordance with the wavelength since the port that outputs the optical signal changes in accordance with the wavelength of the optical signal. For example, once an optical signal obtained by multiplexing the wavelengths λ0, λ1, and λ2 is input to the LN modulator 124, the LN modulator 124 modulates the input optical signal in accordance with the modulation signal, and outputs the output optical signal SO2 including optical signals of the wavelengths 20, 21, and 22. The AWG 131 outputs the optical signal of the wavelength λ0 included in the output optical signal SO2 from a first port, outputs the optical signal of the wavelength λ1 included in the output optical signal SO2 from a second port, and outputs the optical signal of the wavelength λ2 included in the output optical signal SO2 from a third port.

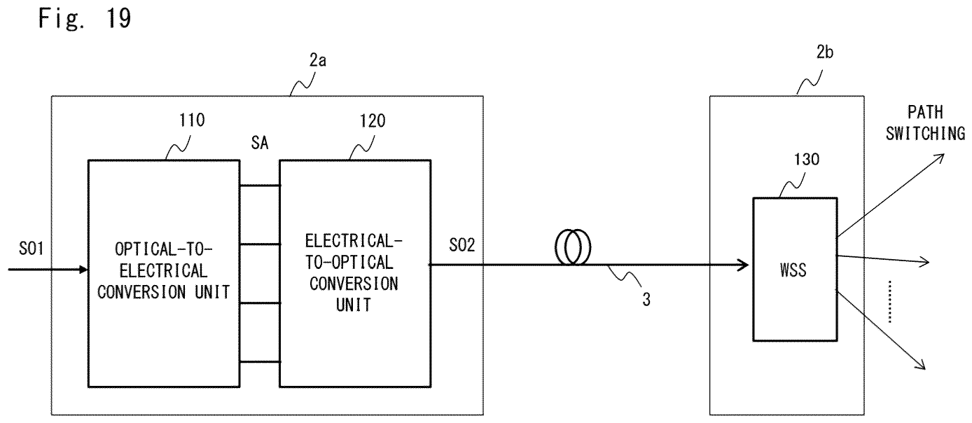

The path switching unit such as a WSS or an AWG may be disposed in another optical relay apparatus 2. As illustrated in FIG. 19, the optical relay apparatus 2 at the next stage of the optical relay apparatus 2 that has performed modulation (duplication) may include the WSS 130. In the example of FIG. 19, an optical relay apparatus 2a (for example, a first optical relay apparatus) and an optical relay apparatus 2b (for example, a second optical relay apparatus) are connected via the optical fiber transmission line 3, the optical relay apparatus 2a at the preceding stage includes the optical-to-electrical conversion unit 110 and the electrical-to-optical conversion unit 120, and the optical relay apparatus 2b at the subsequent stage includes the WSS 130.

The electrical-to-optical conversion unit 120 of the optical relay apparatus 2a transmits the output optical signal SO2 including the modulated optical signals of a plurality of wavelengths to the optical relay apparatus 2b via the optical fiber transmission line 3. The WSS 130 of the optical relay apparatus 2b receives the output optical signal SO2 transmitted through the optical fiber transmission line 3 and switches the output path for each wavelength. The optical relay apparatus 2b may include an optical amplifier that amplifies the power of the optical signals of a plurality of wavelengths included in the received output optical signal SO2, and may input the optical signals of a plurality of wavelengths amplified by the optical amplifier to the WSS 130.

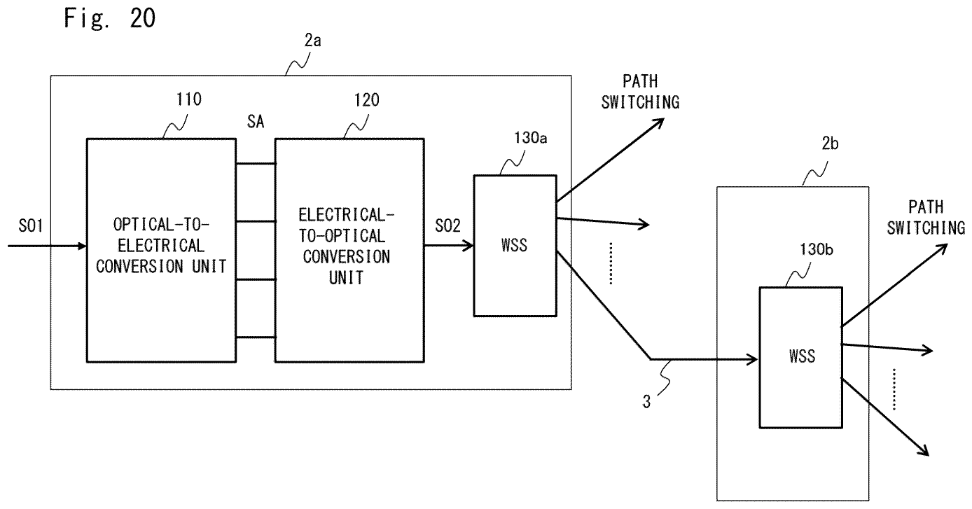

As illustrated in FIG. 20, the output path may be switched in any optical relay apparatus 2. In the example of FIG. 20, the optical relay apparatus 2a at the preceding stage includes an optical-to-electrical conversion unit 110, an electrical-to-optical conversion unit 120, and a WSS 130a, and the optical relay apparatus 2b at the subsequent stage includes a WSS 130b. For example, the output path of the output optical signal SO2 may be switched by either the WSS 130a of the optical relay apparatus 2a at the preceding stage or the WSS 130b of the optical relay apparatus 2b at the subsequent stage, in accordance with the output optical signal SO2 generated by the electrical-to-optical conversion unit 120.

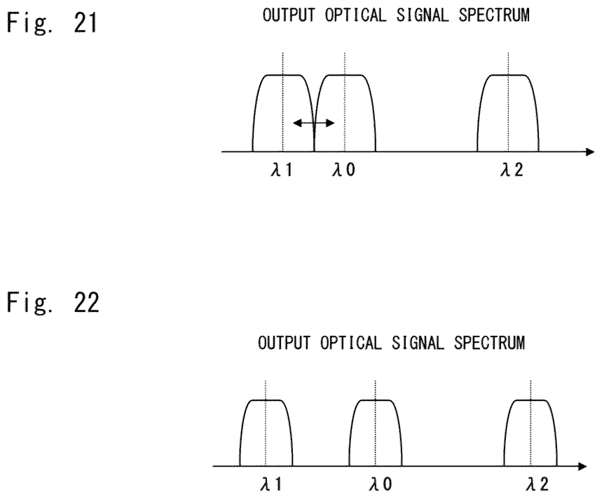

For example, the WSS that switches the output path may be selected in accordance with the spectral arrangement of the output optical signal SO2 as illustrated in FIGS. 21 and 22. FIG. 21 illustrates a spectrum in a case where the electrical-to-optical conversion unit 120 duplicates a signal into an adjacent channel. In the example of FIG. 21, the wavelength channel of λ1 and the wavelength channel of λ0 are adjacent to each other. That is, the wavelength channel of λ1 and the wavelength channel of λ2 are adjacent to each other in a wavelength axis direction (frequency axis direction), and the edge of the spectrum of λ1 and the edge of the spectrum of λ0 are in contact with each other. As illustrated in FIG. 21, while transmitting in a state where the same signals are present in adjacent channels, the signals are distorted due to the impact of the non-linear cross phase modulation (XPM) effect. Therefore, in a case where the wavelength channels of the signals included in the output optical signal SO2 are adjacent to each other, the electrical-to-optical conversion unit 120 of the optical relay apparatus 2a at the preceding stage may output the output optical signal SO2 to the WSS 130a, and the output path of the adjacent wavelength channel signal included in the output optical signal SO2 may be switched by the WSS 130a (immediately after signal duplication).

FIG. 22 illustrates a spectrum in a case where the electrical-to-optical conversion unit 120 duplicates a signal into wavelength-separated channels. In the example of FIG. 22, unlike FIG. 21, the wavelength channel of λ1 and the wavelength channel of λ1 are separated from each other. That is, the wavelength channel of λ1 and the wavelength channel of λ0 are separated from each other without being adjacent to each other in a wavelength axis direction (frequency axis direction), and the spectrum of λ0 and the spectrum of λ0 are not in contact with each other. As illustrated in FIG. 22, in a case where the same signal is assigned to dispersed (or separated) channels, even if the signals are transmitted in this state, the signals are hardly subjected to nonlinear effects caused by XPM. Therefore, in a case where the wavelength channels of the signals included in the output optical signal SO2 are separated (not adjacent), the output optical signal SO2 from the electrical-to-optical conversion unit 120 of the optical relay apparatus 2a at the preceding stage may be transmitted to the optical relay apparatus 2b at the subsequent stage, and the output path of the output optical signal SO2 may be switched by the WSS 130b of the optical relay apparatus 2b at the subsequent stage. In a case where the output optical signal SO2 from the electrical-to-optical conversion unit 120 is transmitted to the optical relay apparatus 2b at the subsequent stage, the output optical signal SO2 may be transmitted via the WSS 130a or may be transmitted by another transmission means. For example, the electrical-to-optical conversion unit 120 may transmit the output optical signal SO2 to the optical relay apparatus 2b at the subsequent stage.

As described above, in the present example embodiment, the optical relay apparatus further includes a path switching unit such as a WSS. Thus, the duplicated output optical signal can be switched to each path for each wavelength, and the communication route can be flexibly selected.

### Third Example Embodiment

Next, a third example embodiment will be described. In the present example embodiment, an example in which a control apparatus controls an input/output wavelength and an output path of an optical relay apparatus will be described.

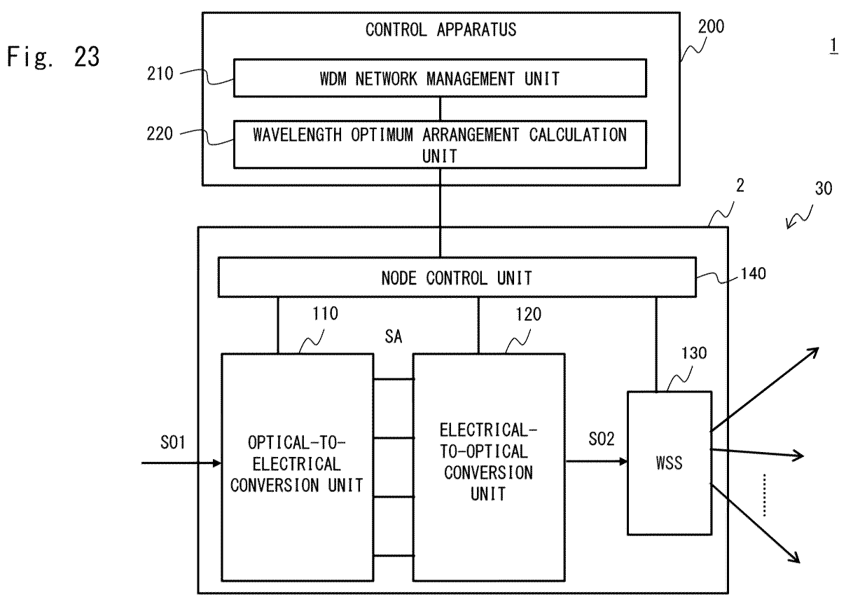

FIG. 23 illustrates a configuration example of the optical transmission system 1 according to the present example embodiment. As illustrated in FIG. 23, the optical transmission system 1 includes a control apparatus 200 that controls the operation of the optical relay apparatus 2. The optical relay apparatus 2 constitutes a WDM network 30. In this example, the optical relay apparatus 2 includes the WSS 130 described in the second example embodiment, and further includes a node control unit 140 that controls each unit of the optical relay apparatus 2. The node control unit 140 acquires information necessary for control by the control apparatus 200, and controls the optical-to-electrical conversion unit 110, the electrical-to-optical conversion unit 120, and the WSS 130 based on the acquired information. The optical relay apparatus 2 duplicates the optical signal and outputs the duplicated optical signal under the control of the control apparatus 200. The present example embodiment may be applied to the optical relay apparatus in the first example embodiment.

The control apparatus 200 manages and controls the WDM network 30 including a plurality of the optical relay apparatuses 2. For example, the control apparatus 200 is a network management system (NMS) that manages a network.

The control apparatus 200 includes a WDM network management unit 210 and a wavelength optimum arrangement calculation unit 220.

The WDM network management unit 210 manages information necessary for management of the WDM network 30. The WDM network management unit 210 may include a database that stores information necessary for network management. For example, the WDM network management unit 210 manages path information, wavelength allocation information, and the like of each optical relay apparatus 2. The path information is information regarding an output path of the optical signal output from each optical relay apparatus 2 (information regarding a port for output, a transmission line of an output destination, or the like). The wavelength allocation information is information regarding wavelengths allocated to the input and output of each optical relay apparatus 2.

The wavelength optimum arrangement calculation unit 220 determines a wavelength to be allocated to each optical relay apparatus 2 or a path based on information managed by the WDM network management unit 210. That is, the wavelength optimum arrangement calculation unit 220 determines the optimum arrangement of wavelengths in the WDM network 30 based on the path information and the wavelength allocation information of each optical relay apparatus 2. For example, the wavelength optimum arrangement calculation unit 220 determines wavelength information (an input wavelength and a plurality of output wavelengths) and path information (an output path for each wavelength) of each optical relay apparatus 2 for setting a new path or a path of a bypass route based on current path information and wavelength allocation information of each optical relay apparatus 2. The wavelength optimum arrangement calculation unit 220 adaptively switches the wavelength and the path of the 1:N signal in the optical relay apparatus 2 in accordance with the state of the WDM network 30. For example, the wavelength optimum arrangement calculation unit 220 determines a wavelength and a path to be used in each optical relay apparatus 2 based on the available wavelength channel in the multicast transmission. The wavelength optimum arrangement calculation unit 220 transmits the determined wavelength information and path information to each optical relay apparatus 2.

The node control unit 140 of the optical relay apparatus 2 receives the wavelength information and the path information from the control apparatus 200 and controls each unit of the optical relay apparatus 2 based on the received information. The node control unit 140 is a wavelength acquisition unit that acquires wavelength information, and is a path acquisition unit that acquires path information.

The node control unit 140 sets a wavelength (in) of the local oscillator light LO to the local oscillator light source 111 of the optical-to-electrical conversion unit 110 based on the input wavelength included in the acquired wavelength information. The local oscillator light source 111 outputs the local oscillator light LO of the set wavelength under the control of the node control unit 140 (control apparatus 200). The node control unit 140 sets the wavelengths (λout1 to λoutN) of the transmission light beams POI to PON to the transmission light sources 121-1 to 121-N of the electrical-to-optical conversion unit 120 based on a plurality of output wavelengths included in the acquired wavelength information. The transmission light sources 121-1 to 121-N output the transmission light beams PO1 to PON of the set wavelengths. The LN modulator 124 collectively modulates the transmission light beams POI to PON of the set wavelengths to the output optical signal SO2. Thus, under the control of the node control unit 140 (control apparatus 200), the signal is duplicated into a plurality of wavelengths. On/off of the transmission light sources 121-1 to 121-N may be controlled to change the number of wavelengths of the output optical signal SO2. The node control unit 140 sets the output path for each wavelength of the WSS 130 based on the acquired path information. The WSS 130 switches the output path of each wavelength of the output optical signal SO2 under the control of the node control unit 140 (control apparatus 200).

Note that, as illustrated in FIG. 20 of the second example embodiment, in a case where the output path is switched in any of the optical relay apparatuses 2, the control apparatus 200 may select the optical relay apparatus 2 that switches the output path. For example, as illustrated in FIGS. 21 and 22, the wavelength optimum arrangement calculation unit 220 may determine whether the output wavelengths are adjacent to each other based on the determined output wavelength. In a case where the output wavelengths are adjacent to each other, the WSS 130a of the optical relay apparatus 2a at the preceding stage of FIG. 20 may be instructed to switch the output path, and in a case where the output wavelengths are not adjacent to each other, the WSS 130b of the optical relay apparatus 2b at the subsequent stage of FIG. 20 may be instructed to switch the output path.

As described above, in the present example embodiment, a control apparatus, which manages the WDM network, controls the input/output wavelength and the output path of the optical relay apparatus. Thus, it is possible to adaptively switch the wavelength of the 1:N input/output signal of the optical relay apparatus and the output path of each wavelength in accordance with the state of the WDM network.

### Fourth Example Embodiment

Next, a fourth example embodiment will be described. In the present example embodiment, a configuration example of automatic bias control of an optical modulator will be described. The present example embodiment may be applied to an optical relay apparatus in any one of the first to third example embodiments.

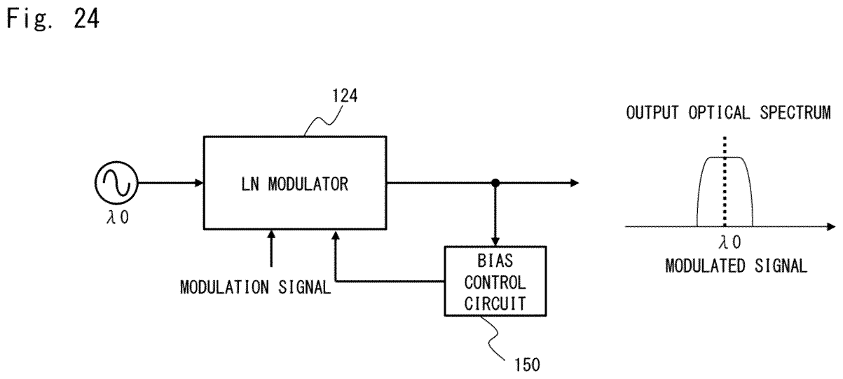

FIG. 24 illustrates a configuration example of the related automatic bias control. As illustrated in FIG. 24, normally, a bias control circuit (automatic bias control circuit (ABC circuit)) 150 that controls a bias voltage of the LN modulator 124 is connected to the LN modulator 124.

The bias control circuit 150 branches and monitors the output light of the LN modulator 124, and feedback-controls the bias voltage of the LN modulator 124 in accordance with the monitored result of the output light, thereby automatically optimizing the bias voltage. As illustrated in FIG. 24, in the related technology, since the LN modulator 124 receives an optical signal of a single wavelength (λ0) and outputs the optical signal of a single wavelength (λ0) modulated in accordance with the modulation signal, the bias control circuit 150 performs optimization control (automatic bias control) on the bias voltage on the assumption of modulation of the single wavelength.

Therefore, in a case where the LN modulator 124 modulates and outputs optical signals of a plurality of wavelengths as in the first example embodiment, there is a possibility that the bias control circuit 150 cannot appropriately perform automatic bias control. That is, since the power of the monitored optical signal is different in a case where the optical signal of a single wavelength is monitored and in a case where the optical signals of a plurality of wavelengths are monitored, the optimum value of the bias voltage deviates from the assumed value, and the bias voltage cannot be controlled to be an appropriate value.

Therefore, in the present example embodiment, a bias control circuit (bias control unit) that controls the bias voltage of the LN modulator 124 based on the optical signal modulated by the LN modulator 124 is provided, and even in a case where the LN modulator 124 outputs optical signals of a plurality of wavelengths, the automatic bias control can be appropriately performed.

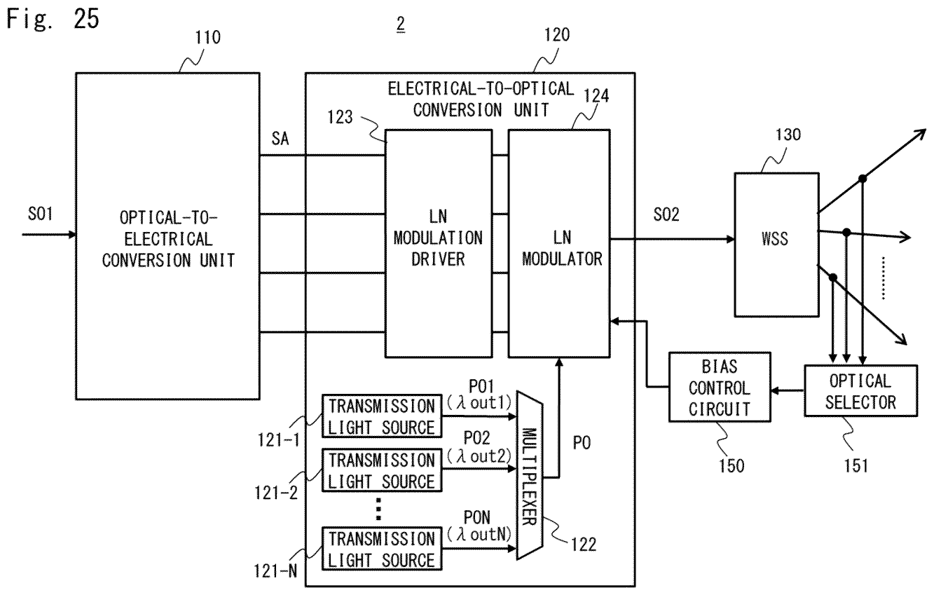

FIGS. 25 to 27 illustrate configuration examples of the optical relay apparatus according to the present example embodiment. FIGS. 25 to 27 illustrate examples in which the present example embodiment is applied to the optical relay apparatus including the WSS 130 of the second example embodiment.

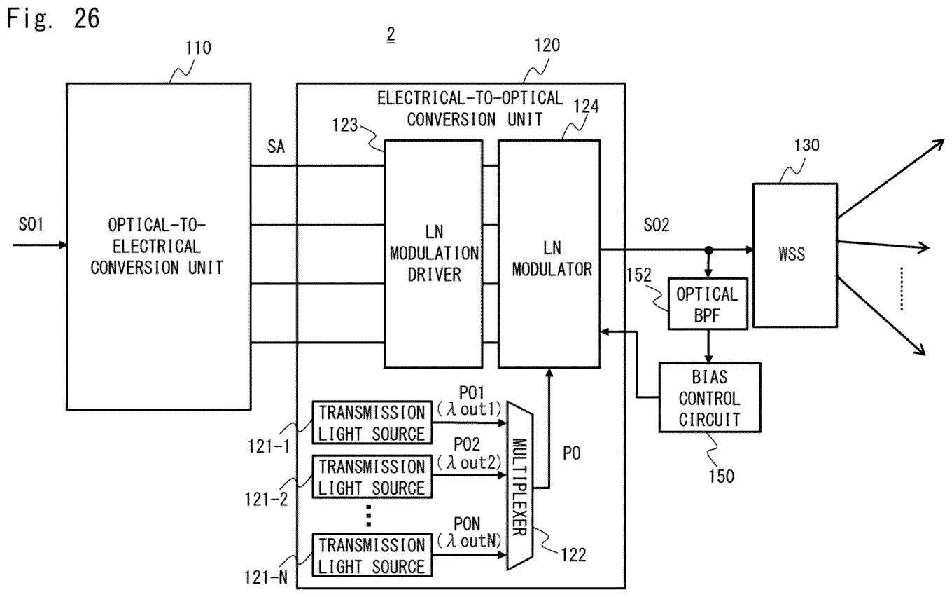

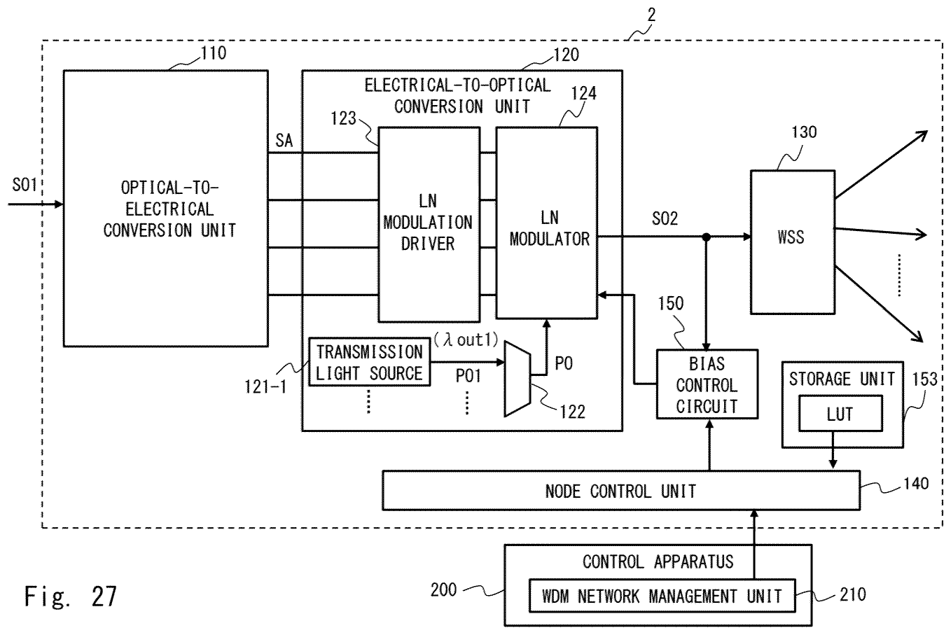

In the examples of FIGS. 25 and 26, the bias voltage is controlled based on the optical signal of one wavelength included in the output optical signal SO2 modulated by the LN modulator 124. In the example of FIG. 25, the optical signal output from any one of the output paths of the WSS 130 that is the path switching unit is monitored to perform bias control. As illustrated in FIG. 25, the optical relay apparatus 2 includes a bias control circuit 150 and an optical selector 151 in addition to the configuration of the second example embodiment. The optical selector (optical selection unit) 151 selects one of the optical signals output from the WSS 130 to each path, and outputs the selected optical signal to the bias control circuit 150. Since the optimum value of the bias voltage is less affected by the wavelength of the optical signal to be monitored, an optical signal of any one of λout1 to λoutN may be selected. In a case where there is a possibility that the signals of the minimum wavelength (λout1) and the maximum wavelength (λoutN) among λout1 to λoutN are degraded, an optical signal of a wavelength (for example, any one of λout2 to λoutN-1) closer to the center than the minimum wavelength and the maximum wavelength (edge sides) may be selected. The optical selector 151 may switch an optical signal to be selected. The bias control circuit 150 feedback-controls the bias voltage of the LN modulator 124 based on the optical signal of one wavelength selected by the WSS 151.

In the example of FIG. 26, only one signal is extracted from the output optical signals of the LN modulator 124 using an optical band pass filter (BPF) to perform bias control. As illustrated in FIG. 26, the optical relay apparatus 2 includes a bias control circuit 150 and an optical BPF 152 in addition to the configuration of the second example embodiment. The optical BPF (optical filter unit) 152 receives the output optical signal SO2 from the LN modulator 124 and transmits only an optical signal of any wavelength among the output optical signals SO2. The optical BPF 152 may transmit an optical signal of any one of λout1 to λoutN. In a case where there is a possibility that the signals of the minimum wavelength (λout1) and the maximum wavelength (λoutN) among λout1 to λoutN are degraded, an optical signal of a wavelength (for example, any one of λout2 to λoutN-1) closer to the center than the minimum wavelength and the maximum wavelength (edge sides) may be transmitted. The optical BPF 152 may be a variable bandwidth filter, and an optical signal to be transmitted may be switched. The bias control circuit 150 feedback-controls the bias voltage of the LN modulator 124 based on the optical signal of one wavelength transmitted through the optical BPF 152.

In the example of FIG. 27, the bias voltage is controlled based on the output optical signal SO2 modulated by the LN modulator 124. In the example of FIG. 27, the output optical signal SO2 of the LN modulator 124 is monitored, and bias control is performed using control parameters corresponding to the number of wavelengths of the output optical signal. As illustrated in FIG. 27, the optical relay apparatus 2 includes a bias control circuit 150, a storage unit 153, and a node control unit 140 in addition to the configuration of the second example embodiment.

The storage unit 153 stores a lookup table (LUT) in which optimum control parameters for each number of wavelengths are set. The behavior of the bias control circuit 150 upon signals of a plurality of wavelengths are input is measured in advance, and the optimum control parameters for each number of wavelengths are recorded in the LUT. The LUT is a control parameter table in which the number of wavelengths is associated with a control parameter. The control parameter is a parameter used by the bias control circuit 150 to obtain an optimum bias voltage in accordance with the monitored result (power) of the optical signal.

The node control unit 140 is a wavelength number acquisition unit that acquires, from the control apparatus 200, information (wavelength number information) regarding the number of wavelengths of the output optical signal SO2 output by the optical relay apparatus 2. For example, the WDM network management unit 210 of the control apparatus 200 described in the third example embodiment may manage the wavelength information (input wavelength and output wavelength) of each optical relay apparatus 2 and notify the node control unit 140 of the information regarding the number of wavelengths output by each optical relay apparatus 2. The node control unit 140 determines optimum control parameters of the bias control circuit 150 in accordance with the number of wavelengths (the number of signal channels) based on the acquired wavelength number information. In this example, the node control unit 140 refers to the LUT of the storage unit 153, reads the control parameters corresponding to the acquired wavelength number information from the LUT, and determines the optimum control parameters. The node control unit 140 sets the determined control parameters in the bias control circuit 150. A means for obtaining the control parameters corresponding to the number of wavelengths is not limited to the LUT. For example, the control parameters corresponding to the number of wavelengths may be modeled by a mathematical formula or the like, and the number of wavelengths may be input to the model to calculate the control parameters.

The bias control circuit 150 monitors the output optical signal SO2 including a plurality of wavelengths output from the LN modulator 124, and obtains the optimum bias voltage corresponding to the optical signals including a plurality of wavelengths by using the control parameters set by the node control unit 140. The bias control circuit 150 may determine (acquire) optimum control parameters from the LUT of the storage unit 153 based on the wavelength number information acquired by the node control unit 140.

As described above, in the present example embodiment, for example, an optical signal of one wavelength output from the path switching unit or an optical signal of one wavelength extracted by the BPF is monitored, and automatic bias control is performed. Optical signals including a plurality of wavelengths are monitored, and automatic bias control is performed using parameters corresponding to the number of wavelengths. Thus, even in a case where the LN modulator outputs the optical signals of a plurality of wavelengths, automatic bias control can be appropriately performed.

The present disclosure is not limited to the above-described example embodiments, and can be appropriately modified without departing from the scope.

Each configuration in the above-described example embodiments may be implemented by hardware, software, or both, and may be implemented by one piece of hardware or software or by a plurality of pieces of hardware or software. The functions (processes) of each apparatus (control apparatus) may be implemented by a computer including a central processing unit (CPU) and a memory. For example, a program for performing the method in the example embodiment may be stored in a storage apparatus, and each function may be implemented by executing the program stored in the storage apparatus by the CPU.

These programs include a group of instructions (or software codes) for causing a computer to perform one or more functions described in the example embodiments in a case of being read by the computer. The program may be stored in a non-transitory computer readable medium or a tangible storage medium. By way of example and not by way of limitation, the computer readable medium or the tangible storage medium includes a random-access memory (RAM), a read-only memory (ROM), a flash memory, a solid-state drive (SSD) or any other memory technique, a CD-ROM, a digital versatile disc (DVD), a Blu-ray (registered trademark) disc or any other optical disc storage, and a magnetic cassette, a magnetic tape, a magnetic disk storage, or any other magnetic storage device. The program may be transmitted through a transitory computer readable medium or a communication medium. By way of example and not by way of limitation, transitory computer-readable or communication media include electrical, optical, acoustic, or other forms of propagated signals.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims.

Some or all of the above example embodiments can also be described as the following supplementary notes, but are not limited to the following.

### (Supplementary Note 1)

An optical relay apparatus including:
an optical reception means for receiving an optical signal of a single wavelength; and
an optical transmission means for duplicating the received optical signal into optical signals of a plurality of wavelengths and transmitting each of the duplicated optical signals.

### (Supplementary Note 2)

The optical relay apparatus according to Supplementary Note 1, in which the optical transmission means includes
a plurality of transmission light sources that output transmission light beams of different wavelengths, and
a modulation means for performing the duplication based on a plurality of transmission light beams from the plurality of transmission light sources.

### (Supplementary Note 3)

The optical relay apparatus according to Supplementary Note 2, in which
the optical reception means performs coherent detection on the received optical signal based on local oscillator light to convert the received optical signal into an electrical signal, and
the modulation means performs the duplication by collectively modulating the plurality of transmission light beams with the electrical signal.

### (Supplementary Note 4)

The optical relay apparatus according to Supplementary Note 3, in which
the optical transmission means includes a multiplexing means for multiplexing the plurality of transmission light beams, and
the modulation means collectively modulates the multiplexed optical signal with the electrical signal.

### (Supplementary Note 5)

The optical relay apparatus according to any one of Supplementary Notes to 4, further including a wavelength acquisition means for acquiring wavelength information of each of the duplicated optical signals, in which the plurality of transmission light sources output transmission light beams of wavelengths corresponding to the acquired wavelength information.

(supplementary Note 6)

The optical relay apparatus according to any one of Supplementary Notes to 5, further including a bias control means for controlling a bias voltage of the modulation means based on the duplicated optical signals.

### (Supplementary Note 7)

The optical relay apparatus according to Supplementary Note 6, in which the bias control means controls the bias voltage based on control parameters corresponding to the number of wavelengths of the duplicated optical signals.

### (Supplementary Note 8)

The optical relay apparatus according to Supplementary Note 7, further including a wavelength number acquisition means for acquiring wavelength number information of the duplicated optical signals,
in which the bias control means determines the control parameters based on the acquired wavelength number information.

### (Supplementary Note 9)

The optical relay apparatus according to Supplementary Note 8, further including a storage means for storing a control parameter table in which the number of wavelengths is associated with control parameters, in which the bias control means refers to the control parameter table and determines control parameters corresponding to the wavelength number information.

(supplementary Note 10)

The optical relay apparatus according to Supplementary Note 6, in which the bias control means controls the bias voltage based on an optical signal of one wavelength included in each of the duplicated optical signals.

### (Supplementary Note 11)

The optical relay apparatus according to Supplementary Note 10, further including a filter means for transmitting the optical signal of one wavelength from the duplicated optical signals,
in which the bias control means controls the bias voltage based on an optical signal transmitted through the filter means.

### (Supplementary Note 12)

The optical relay apparatus according to Supplementary Note 10, further including a path switching means for switching an output path of the duplicated optical signal for each wavelength,
in which the bias control means controls the bias voltage based on an optical signal output from any one of the output paths of the path switching means.
   (Supplementary Note 13) The optical relay apparatus according to any one of Supplementary Notes 1 to 11, further including a path switching means for switching an output path of the duplicated optical signal for each wavelength.

### (Supplementary Note 14)

The optical relay apparatus according to Supplementary Note 13, in which the path switching means is a wavelength selection switch or an arrayed waveguide grating.

### (Supplementary Note 15)

The optical relay apparatus according to Supplementary Note 13 or 14, further including an output path acquisition means for acquiring output path information for each wavelength,
in which the path switching means switches the output path of the duplicated optical signal based on the acquired output path information.

### (Supplementary Note 16)

An optical transmission system including a plurality of optical relay apparatuses, in which the plurality of optical relay apparatuses include
an optical reception means for receiving an optical signal of a single wavelength from an optical relay apparatus at a preceding stage, and an optical transmission means for duplicating the received optical signal into optical signals of a plurality of wavelengths and transmitting each of the duplicated optical signals to an optical relay apparatus at a subsequent stage.

### (Supplementary Note 17)

The optical transmission system according to Supplementary Note 16, further including a control apparatus that controls the plurality of optical relay apparatuses,
in which the optical transmission means performs the duplication under the control of the control apparatus.

### (Supplementary Note 18)

The optical transmission system according to Supplementary Note 17, in which
the plurality of optical relay apparatuses include a path switching means for switching an output path of the duplicated optical signal for each wavelength, and
the path switching means switches the output path of the duplicated optical signal under the control of the control apparatus.

### (Supplementary Note 18)

The optical transmission system according to Supplementary Note 18, in which
the plurality of optical relay apparatuses include a first optical relay apparatus and a second optical relay apparatus,
the optical transmission means in the first optical relay apparatus transmits the duplicated optical signal to the second optical relay apparatus, and
the path switching means in the second optical relay apparatus switches an output path of the optical signal received from the first optical relay apparatus.

### (Supplementary Note 20)

The optical transmission system according to Supplementary Note 19, in which
in a case where wavelengths included in the duplicated optical signals are adjacent to each other,
the path switching means in the first optical relay apparatus switches the output path of the optical signal output by the optical transmission means, and
in a case where the wavelengths included in the duplicated optical signals are not adjacent to each other,
the optical transmission means in the first optical relay apparatus transmits the duplicated optical signal to the second optical relay apparatus, and the path switching means in the second optical relay apparatus switches the output path of the optical signal received from the first optical relay apparatus.

### (Supplementary Note 21)

An optical relay method including:
receiving an optical signal of a single wavelength; and
duplicating the received optical signal into optical signals of a plurality of wavelengths and transmitting each of the duplicated optical signals.

### REFERENCE SIGNS LIST

1 optical transmission system
2 optical relay apparatus
3 optical fiber transmission line
4 data center
6 IT service provider
7,8 event venue
11 stadium
12, 13 public viewing venue
21 optical reception unit
22 optical transmission unit
30 WDM network
110 optical-to-electrical conversion unit
111 local oscillator light source
112 90-degree optical hybrid
111 photodetector
114 transimpedance amplifier
120 electrical-to-optical conversion unit
121 transmission light source
122 multiplexer
123 LN modulation driver
124 LN modulator
140 node control unit
150 bias control circuit
151 optical selector
152 optical BPF
153 storage unit
200 control apparatus
210 WDM network management unit
220 wavelength optimum arrangement calculation unit
301 analog signal processing unit
302 A/D converter
303 digital signal processing unit
304 D/A converter

What is claimed is:

1. An optical relay apparatus comprising:
an optical receiver receiving an optical signal of a single wavelength; and
an optical transmitter duplicating the received optical signal into optical signals of a plurality of wavelengths and transmitting each of the duplicated optical signals.

2. The optical relay apparatus according to claim 1, wherein the optical transmitter includes
a plurality of transmission light sources that output transmission light beams of different wavelengths, and
a modulator performing the duplication based on a plurality of transmission light beams from the plurality of transmission light sources.

3. The optical relay apparatus according to claim 2, wherein
the optical receiver performs coherent detection on the received optical signal based on local oscillator light to convert the received optical signal into an electrical signal, and
the modulator modulation means performs the duplication by collectively modulating the plurality of transmission light beams with the electrical signal.

4. The optical relay apparatus according to claim 3, wherein
the optical transmitter includes a multiplexer multiplexing the plurality of transmission light beams, and
the modulator collectively modulates the multiplexed optical signal with the electrical signal.

5. The optical relay apparatus according to claim 2, further comprising a wavelength acquisitor for acquiring wavelength information of each of the duplicated optical signals,
wherein the plurality of transmission light sources output transmission light beams of wavelengths corresponding to the acquired wavelength information.

6. The optical relay apparatus according to claim 2, further comprising a bias controller controlling a bias voltage of the modulator based on the duplicated optical signals.

7. The optical relay apparatus according to claim 6, wherein the bias controller controls the bias voltage based on control parameters corresponding to the number of wavelengths of the duplicated optical signals.

8. The optical relay apparatus according to claim 7, further comprising a wavelength number acquisitor acquiring wavelength number information of the duplicated optical signals,
wherein the bias controller determines the control parameters based on the acquired wavelength number information.

9. The optical relay apparatus according to claim 8, further comprising a storage storing a control parameter table in which the number of wavelengths is associated with control parameters,
wherein the bias controller refers to the control parameter table and determines control parameters corresponding to the wavelength number information.

10. The optical relay apparatus according to claim 6, wherein the bias controller controls the bias voltage based on an optical signal of one wavelength included in each of the duplicated optical signals.

11. The optical relay apparatus according to claim 10, further comprising a filter transmitting the optical signal of one wavelength from the duplicated optical signals,
wherein the bias controller controls the bias voltage based on an optical signal transmitted through the filter.

12. The optical relay apparatus according to claim 10, further comprising a path switch switching an output path of the duplicated optical signal for each wavelength,
wherein the bias controller controls the bias voltage based on an optical signal output from any one of the output paths of the path switch means.

13. The optical relay apparatus according to claim 1, further comprising a path switch an output path of the duplicated optical signal for each wavelength.

14. The optical relay apparatus according to claim 13, wherein the path switch is a wavelength selection switch or an arrayed waveguide grating.

15. The optical relay apparatus according to claim 13, further comprising an output path acquisitor acquiring output path information for each wavelength,
wherein the path switch switches the output path of the duplicated optical signal based on the acquired output path information.

16. An optical transmission system comprising a plurality of optical relay apparatuses, wherein the plurality of optical relay apparatuses include
an optical receiver receiving an optical signal of a single wavelength from an optical relay apparatus at a preceding stage, and
an optical transmitter duplicating the received optical signal into optical signals of a plurality of wavelengths and transmitting each of the duplicated optical signals to an optical relay apparatus at a subsequent stage.

17. The optical transmission system according to claim 16, further comprising a control apparatus that controls the plurality of optical relay apparatuses,
wherein the optical transmitter performs the duplication under the control of the control apparatus.

18. The optical transmission system according to claim 17, wherein
the plurality of optical relay apparatuses include a path switch switching an output path of the duplicated optical signal for each wavelength, and
the path switch switches the output path of the duplicated optical signal under the control of the control apparatus.

19. The optical transmission system according to claim 18, wherein
the plurality of optical relay apparatuses include a first optical relay apparatus and a second optical relay apparatus,
the optical transmitter in the first optical relay apparatus transmits the duplicated optical signal to the second optical relay apparatus, and
the path switch in the second optical relay apparatus switches an output path of the optical signal received from the first optical relay apparatus.

20. (Canceled)

21. An optical relay method comprising:
receiving an optical signal of a single wavelength; and
duplicating the received optical signal into optical signals of a plurality of wavelengths and transmitting each of the duplicated optical signals.
